(19) United States
(12) Patent Application Publication
(10) Pub. No.: US 2014/0124068 A1
(43) Pub. Date: May 8, 2014

(54) TANK OVERFLOW PIPE SYSTEM

(71) Applicant: FLUOR TECHNOLOGIES CORPORATION, Also Viejo, CA (US)

(72) Inventor: Dennis W. Johnson, Simpsonville, SC (US)

(73) Assignee: FLUOR TECHNOLOGIES CORPORATION, Aliso Viejo, CA (US)

(21) Appl. No.: 14/070,994

(22) Filed: Nov. 4, 2013

Related U.S. Application Data
(60) Provisional application No. 61/721,772, filed on Nov. 2, 2012.

(51) Int. Cl. G05D 9/02

(52) U.S. Cl. CPC G05D 9/02
USPC 137/561 R

(57) ABSTRACT

Overflow systems are described for non-atmospheric pressure, slurry tank, which can reduce stagnation of excess flurry in an overflow pipe. In such systems, stagnation of the excess slurry in the overflow pipe is reduced via a recirculation conduit that allows for recirculation of at least a portion of the slurry from the tank. Moreover, an air capture unit collects a portion of an oxidation air from the tank. As a result, the fluid in the overflow system is representative of the aerated slurry within the tank.

This application claims priority to U.S. provisional application having Ser. No. 61/721,772 filed on Nov. 2, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is overflow systems for non-atmospheric pressure tanks.

### BACKGROUND

The following description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Various configurations of overflow systems are well known in the art. With respect to flue gas desulfitrization systems and other systems having non-atmospheric pressure slurry tanks, overflow systems are critical to prevent flow back into an inlet conduit that could otherwise lead to significant problems. Limestone forced oxidation systems can be especially problematic because they generally have a two-phase slurry (solid and liquid) and the tank is aerated with air used to oxidize the reaction product of SO₂ and CaCO₃ into CaSO₄.2H₂O (gypsum).

General configurations of overflow devices can be found in China Patent Publication Nos. 101164671 to China Shenhua Energy Stock Co., Ltd., and 102343214 to Liu Yong, which describe two configurations of overflow devices used in flue gas desulfurization systems. However, such configurations typically have stagnant flow, allowing the solids to settle. In addition, such configurations fail to account for oxidation air that can lead to formation of froth.

Typical overflow devices use an overflow pipe to transmit excess material out of a tank. However, overflow devices have been implemented within a tank. For example, China Patent Publication No. 101612513 to Bohai University discloses a multi-stage flue gas desulfurization absorber having a gas overflow pipe, which allows a gas to travel from one stage to another when the gas-volume exceeds the height of the overflow pipe. However, such system can be problematic because it may require extensive modification of a typical absorber.

Other known general overflow solutions are described in Great Britain Patent Publication Nos. 705040 to the Dorr Company and 2159507 to Mitsubishi Jukogyo Kabushiki Kaisha. However, such solutions also suffer from one or more disadvantages.

Thus, there is still a need for improved overflow systems for use with non-atmospheric pressure slurry tanks that prevent flow back into the fluid inlet.

### SUMMARY OF THE INVENTION

The inventive subject matter provides apparatus, systems and methods in which an overflow system for non-atmospheric pressure, slurry tank can be used to reduce stagnation of excess slurry in an overflow pipe. In such systems, an overflow pipe is fluidly coupled to the tank to allow for removal of excess slurry from the tank. Preferably, a recirculation conduit coupled to the overflow pipe can be used to reduce stagnation of the excess slurry in the overflow pipe by allowing for recirculation of at least a portion of the slurry from the tank.

In another aspect, it is contemplated that a tank configured to store slurry produced by a flue gas desulfurization or other gas conditioning system has an inlet conduit that receives slurry. Air is introduced into the tank via an air inlet to allow for oxidation of at least a portion of the slurry. The tank can include an overflow pipe through which excess slurry can be removed from the tank. A portion of the excess slurry is recirculated via a recirculation conduit that is fluidly coupled to the overflow pipe. The overflow pipe also preferably includes an air capture unit at an inlet to the overflow pipe, and disposed within the tank. The air capture unit can advantageously be configured to allow collection of some of the oxidation air from the tank so the conditions of the fluid in the overflow are similar to the slurry within the tank.

In yet another aspect, an air capture unit is disclosed for a tank having slurry. The air capture unit comprises a conical piece attached to a fluid conduit. The conical piece is preferably disposed within the tank, such that the conical piece is located at a height below a normal liquid level of the tank. Moreover, the conical piece has an opening that is directed downwardly with respect to the tank. Preferably, the mouth of the opening comprises a maximum diameter of the conical piece with the diameter decreasing along a length of the conical piece. By disposing the air capture unit below a normal liquid level of the tank, at least a portion of oxidation air within the shiny can be collected such that the fluid in the overflow is similar to that in the tank.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1-2 are schematics of prior art overflow systems.

FIG. 3 is a schematic of one embodiment of overflow system for use with a tank having a pressurized fluid.

FIG. 4 is an enlarged view of Area A in FIG. 3.

FIG. 5 is an enlarged view of Area B in Fig.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Furthermore, as used herein, slurry is a liquid-solid mixture that is either introduced into a tank or is generated (e.g., limestone forced oxidation) in the tank. Excess slurry is considered to be slurry above a normal liquid level of a tank that typically enters an overflow pipe to prevent flow-back into an inlet of the tank. Recirculation of slurry can comprise of slurry within the tank and excess slurry that is either above the normal liquid level of the tank or within the overflow pipe.

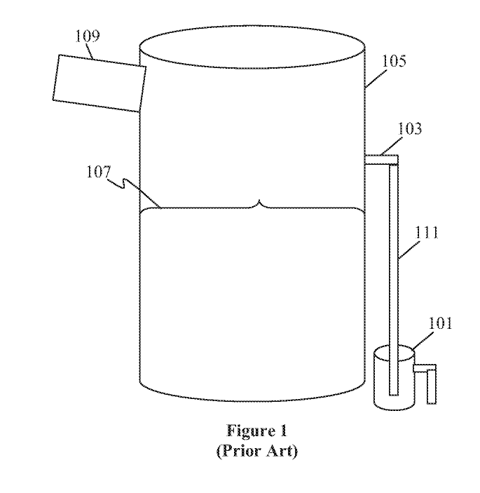

FIG. 1 illustrates a prior art configuration of a seal box 101 in which an overflow connection 103 of an absorber recirculation tank 105 is located above a normal liquid level 107. When overflow occurs, slurry enters the seal box 101, which is utilized to prevent gas leaking out of or into the FGD tower via flue gas inlet 109. However, such configuration is problematic because solids can separate from the slurry and plug an overflow pipe 111. In addition, such systems typically require installation of a seal box type overflow, which must be frequently inspected to monitor for clogs.

FIG. 2 illustrates a prior art configuration of a trap-type overflow system 200 for a tank 202 having an overflow connection 201 positioned safely below a normal liquid level 201. In such systems, the liquid level 203 is maintained well below a flue gas inlet 204 to accommodate the inferior performance of the overflow system 200. A siphon break 205 can be included to prevent siphoning during overflow. Such configuration is also problematic as the overflow can quickly become stagnant with little or no flow. This can result in the solids in the overflow connection 201 settling and separating from the liquid. With the separation of the solids, the liquid is less dense and the tank 202 will often overflow before the actual level in the tank reaches its maximum. When overflow occurs, the solids return and the levels balance. In addition, these systems are prone to plugging with the stagnant solids in the immersed portion of the overflow pipe 207.

In addition, the oxidation air used in tank 202 typically displaces the slurry in tank 202, but does not enter into overflow pipe 207 to thereby exit the tank. The oxidation air is instead likely to accumulate, which can increase the liquid level in the tank and may lead to formation of froth on the surface. Because the trap-type overflow system 200 may not contain representative slurry, overflow into inlet 204 may occur due to the settled solids and the lack of aeration. Often, the slurry or froth that enters inlet 204 is dried by the process, creating a maintenance issue for cleaning out the deposit. In extreme cases, the slurry that overflows into inlet 204 can damage the flue work due to corrosion and deposition, and can lead to structural damage due to the weight of the slurry and even problems with upstream fans.

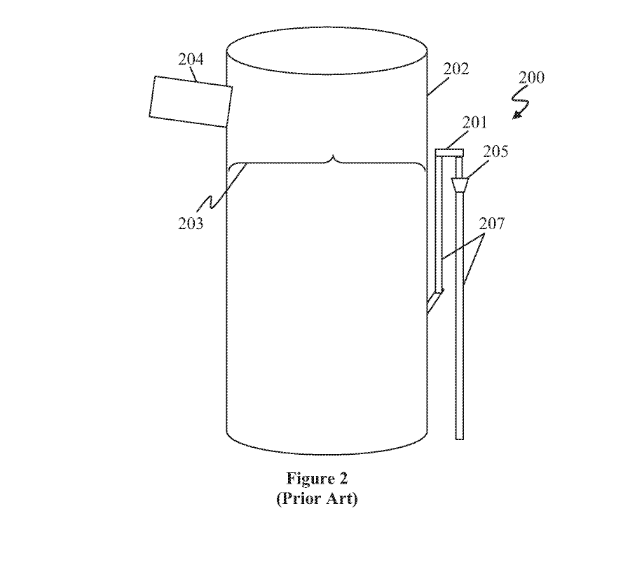

FIG. 3 illustrates an embodiment of an improved trap-type overflow system 300 to prevent flow-back into an inlet 302 to an upstream unit. Importantly, system 300 can include a recirculated flow of the slurry such that the slurry in a recirculation conduit 313 is always almost equivalent or near equivalent (i.e., approximately 95% equal composition) to the bulk content of the tank 303. Preferred systems also include an air capture unit 305 that is installed in the tank 303, and often at an inlet to the overflow pipe 301. The air capture unit 305 advantageously can be used to capture some of the oxidation air to make sure the fluid in the overflow pipe 301 is representative of the bulk slurry in tank 303. It is contemplated that the air capture unit 305 can be sized to approximate the flow of air into it white accounting for the outflow of recirculated slurry. In this manner, the displacement of air in the overflow is similar to the air displacement in the tank.

Tank 303 is typically a flue gas desulfurization (FGD) absorber that operates at pressures above atmospheric pressure. However, tank 303 could also be any other type of slurry tank that is below atmospheric pressure. In preferred embodiments, tank 303 is enclosed and has an overflow system to prevent damage to upstream equipment (e.g., flue gas desulfurization unit). Tank 303 can also be fluidly coupled to a flue gas desulfurization absorber that is operating at a pressure between −2 and +2 psi, for example.

In preferred embodiments, an overflow pipe 301 is coupled to tank 303 at a height that is below a normal liquid level 307 of tank 303 to remove excess slurry from tank 303. Overflow pipe 301 can comprise various sizes and materials to meet overflow requirements of tank 303. For example, in some embodiments, overflow pipe 301 can have a 12-inch diameter to meet overflow size requirements for tank 303. In other embodiments, overflow pipe 301 can have an 18-inch diameter to meet overflow size requirements for tank 303. Of course, the specific dimension of the overflow pipe will depend on the specific application. Similarly, overflow pipe 301 can comprise of a metal with corrosion protection or a corrosive-resistant material where necessary to prevent corrosion damage by deposits of the slurry, or be constructed of a suitable alloy, plastic or fiberglass material.

Overflow pipe 301 can further comprise a siphon break 309 to prevent overflow pipe 301 from siphoning the slurry.

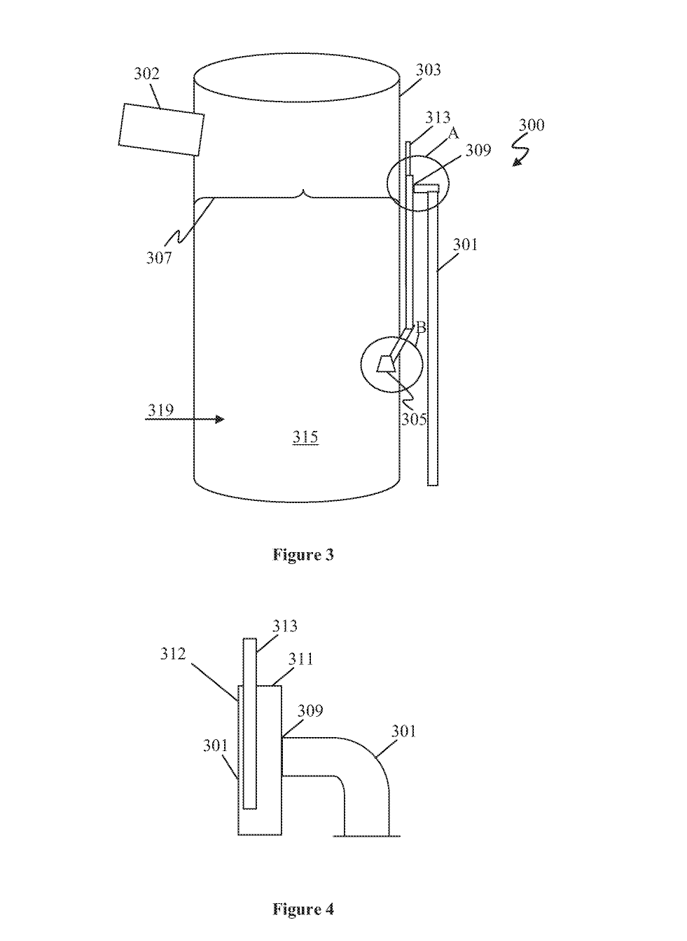

FIG. 4 shows a enlarged view of Area A from FIG. 3, which includes siphon break 309. In contemplated embodiments, siphon break 309 can comprise of a standpipe 312 to advantageously allow for online cleaning when and if required. Siphon break 309 can also comprise a vent and observation opening 311. Although vent and observation opening 311 can provide a cost-effective alternative to other siphoning systems, it is necessary that the air is safely vented and proper equipment is necessary for personnel access.

Preferred embodiments include a recirculation conduit 313 that is fluidly coupled to overflow pipe 301. Recirculation pipe 313 is configured to allow recirculation of a portion of the slurry from tank 303 to reduce stagnation of the excess slurry in overflow pipe 301. Like overflow pipe 301, recirculation conduit 313 can vary in size and material. For example, recirculation conduit 313 can have a diameter that is equal to or less than the diameter of overflow pipe 301. Similarly, recirculation conduit 313 can comprise of a metal with corrosion protection or a corrosive-resistant material where necessary to prevent corrosion damage by deposits of the slurry. Nevertheless, it should be appreciated that recirculation conduit 313 can be sized to produce flow requirements such that a bulk content of the excess slurry disposed within overflow pipe 301 is equal or nearly equal to a bulk content of the slurry disposed within tank 303. In more preferred embodiments, the bulk content of the excess slurry disposed within overflow pipe 301 is within 90% of the bulk content of the slurry disposed within tank 303 and more preferably within 95% of the bulk content of the slurry disposed within tank 303.

Recirculation conduit 313 typically receives the slurry to recirculate from tank 303 via a pump not shown such as an absorber recirculation or bleed pump. In contemplated embodiments, the recirculation conduit 313 and overflow pipe 301 are a single piece. However, recirculation conduit 313 and overflow pipe 301 can comprise separable pieces with different components. The slurry received by recirculation conduit 313 can then be returned to tank 303 at a location below normal liquid level 307 of tank 303, generally through overflow pipe 301.

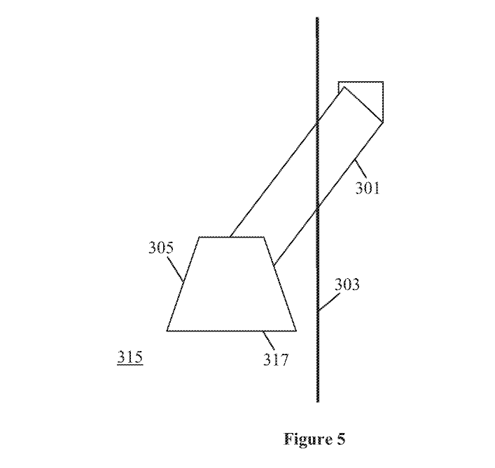

Improved trap-type overflow system 300 can further comprise an air capture unit 305 (e.g., a scoop) that is fluidly coupled to an end portion of overflow pipe 301. FIG. 5 shows an enlarged view of Area B in FIG. 3, which includes air capture unit 305. As shown in FIG. 5, air capture unit 305 can be disposed within 315 tank 303 at a location below normal liquid level 307 of tank 303. Air capture unit 305 is typically configured to allow the collection of some of an oxidation air (e.g., byproduct gas of a reaction between SO₂ and CaCO₃ and air to produce gypsum or unreacted air within tank 303. In preferred embodiments, air capture unit 305 is configured to collect between 0.001% and 0.1% of the oxidation air, such that the amount of air in the overflow pipe 301 is representative of the amount in the bulk slurry within tank 303. Furthermore, air capture unit 305 can be configured to allow discharge slurry from recirculation conduit 313 into tank 303 while capturing a representative amount of air.

Like overflow pipe 301, air capture unit 305 can be of various sizes and materials. In typical embodiments, air capture unit 305 comprises a conical end piece 317 to overflow pipe 301. Conical piece 317 is disposed within tank 303 and is located at a height below a normal liquid level 307 of tank 303 but above the region that oxidation air in introduced (i.e., air inlet 319), such that an opening of the conical piece 317 is directed downwardly (i.e., overlooking the bottom of tank 303) with respect to tank 303. Air capture unit 305 can have the shape of a trapezoid (shape of 305), cone, or any other shape that has a width or diameter that decreases in size from the bottom of the shape to the top of the shape when disposed similarly to that shown in FIG. 5. In such embodiments, a mouth of the air capture unit has a diameter or surface area that is larger than a diameter or surface area of a downstream portion of the unit. Moreover, air capture unit 305 and overflow pipe 301 can comprise of one piece or separate pieces with an attachment.

In preferred embodiments, air capture unit 305 comprises a conical piece 317 that is coupled to a conduit (e.g., overflow pipe 301) to allow collection of a portion of an oxidation air (e.g., byproduct gas of a reaction between SO₂ and CaCO₃ and air to produce gypsum or unreacted air) such that froth is reduced. Such conduit can allow discharge of excess slurry and slurry for recirculation via air capture unit 305.

Tank 303 can further comprise an air inlet 319, which is configured to aerate tank 303. Air inlet 319 can enter the tank to allow for oxidization of at least a portion of the slurry. For example, tank 303 can comprise of a limestone forced oxidation system, wherein tank 303 is aerated with air via air inlet 319 to oxidize the reaction product of SO₂ and CaCO₃ into CaSO₄.2H₂O (gypsum). However, in other contemplated embodiments, tank 303 does not comprise an air inlet because the tank is not aerated.

From the description above, it should be appreciated that the improved trap-type overflow system has numerous advantages over prior art systems. For example, the inclusion of recirculated flow helps to ensure that the slurry within the overflow pipe is almost always equivalent or near equivalent to the bulk content of the FGD absorber tank. In addition, an air capture unit (e.g., scoop) allows for collection of some of the oxidation air. The system can include a stand pipe, preferably provided in the siphon break, which allows for on-line cleaning when necessary, and reduces the cost of the system when compared with the siphon break of other known systems. One must be careful that the small amount of air exiting the improved trap-type overflow may be depleted of oxygen due to reaction in the process. Thus, it is necessary that the air is safely vented and proper equipment is necessary for personnel access.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An overflow system for use with a tank having a slurry, comprising:
an overflow pipe fluidly coupled to the tank, wherein the overflow pipe is configured to allow for removal of excess slurry from the tank; and
a recirculation conduit fluidly coupled to the overflow pipe, wherein the recirculation conduit is configured to allow for recirculation of at least a portion of the slurry from the tank to reduce stagnation of the excess slurry in the overflow pipe.

2. The system of claim 1, further comprising an air capture unit fluidly coupled to an end portion of the overflow pipe disposed within the tank, and configured to allow collection of some of an oxidation air within the tank.

3. The system of claim 1, wherein the tank is fluidly coupled to a flue gas desulfurization absorber operating at a pressure between −2 psi and +2 psi.

4. The system of claim 1, further comprising an air inlet configured to aerate the tank to allow oxidization of a reaction product comprising SO₂ and CaCO₃ into gypsum.

5. The system of claim 1, wherein the overflow pipe is fluidly coupled to the tank at a height that is below a normal liquid level of the tank.

6. The system of claim 1, wherein the overflow pipe further comprises a siphon break that is configured to prevent the overflow pipe from siphoning the slurry.

7. The system of claim 1, wherein a bulk content of the excess slurry is equivalent to a bulk content of the slurry.

8. The system of claim 1, herein the tank has a pressure above or below atmospheric pressure.

9. A tank configured to store a slurry produced by a gas conditioning system, comprising,
an inlet conduit configured to receive a slurry;
an air inlet through which air can enter the tank to allow for oxidization of at least a portion of the slurry;
an overflow pipe fluidly coupled to the tank, and configured to allow for removal of excess slurry from the tank;
a recirculation conduit fluidly coupled to the overflow pipe, and configured to remove at least a portion of the slurry and feed the portion of the slurry to the tank; and
an air capture unit comprising an inlet to the overflow pipe, wherein the air capture unit is disposed within the tank, and wherein the air capture unit is configured to allow collection of oxidation air from the tank.

10. The system of claim 9, wherein the air capture unit is further configured to allow capture of the excess slurry.

11. The system of claim 9, wherein the air capture unit is a conical opening that is oriented in a direction that overlooks a bottom surface of the tank.

12. The system of claim 9, wherein the air capture unit is located at a height below a normal liquid level of the tank.

13. The system of claim 9, wherein the recirculation conduit is configured to allow for recirculation of the slurry from the tank such that a bulk content of the excess slurry is within 90% of a bulk content of the slurry.

14. The system of claim 9, wherein the overflow pipe further comprises a siphon break.

15. The system of claim 14, wherein the siphon break comprises a standpipe.

16. An air capture unit for a tank having slurry, comprising:
a conical piece that is disposed within the tank, wherein the conical piece is located at a height below a normal liquid level of the tank, and such that an opening of the conical piece is directed downwardly with respect to the tank; and
a conduit coupled to the conical piece, wherein the conduit is configured to allow collection of a portion of an oxidation air such that an amount of air in the conical piece is representative of an amount of air within the tank.

17. The unit of claim 16, wherein the air capture unit comprises a trapezoid shape or a cone shape.

18. The unit of claim 16, wherein the conduit is further coupled to a siphon break.

19. The unit of claim 16, further comprising an air inlet coupled to the tank, wherein the air inlet is configured to allow an oxidation air to enter the tank.
